(19) United States
(12) Patent Application Publication
(10) Pub. No.: US 2017/0024983 A1
(43) Pub. Date: Jan. 26, 2017

(54) SYSTEM AND METHOD FOR TAMPER DETECTION ON DISTRIBUTED UTILITY INFRASTRUCTURE

(71) Applicant: THE TRUSTEES OF DARTMOUTH COLLEGE, HANOVER, NH (US)

(72) Inventors: Jason Reeves, Lyme, NH (US); Sean Smith, Hanover, NH (US)

(21) Appl. No.: 15/215,083

(22) Filed: Jul. 20, 2016

Related U.S. Application Data
(60) Provisional application No. 62/194,639, filed on Jul. 20, 2015.

(51) Int. Cl. G08B 13/02

(52) U.S. Cl. CPC G08B 13/02

(57) ABSTRACT

A system and method are disclosed that use information from a distributed, sensor-based network to decide if unwanted tampering is occurring within a utility infrastructure and how to respond. The system and method receive data from sensors located in embedded devices on the edge of the network (i.e., edge devices) and process the data to identify the presence or absence of indicators. A factor graph is generated and. updated with the indicators, along with historical incident and user-defined data, and relationships between the sensors. Based upon the factor graph, the system and method determine what events are occurring at edge devices and decide whether the events are tamper events caused by unwanted tampering. Enforcement programs are used to appropriately mitigate the tamper events.

### CROSS-REFERENCE TO RELATED APPLICATION

This application claims the benefit of priority to U.S. Provisional Patent Application No. 62/194,639 filed Jul. 20, 2015, which is incorporated by reference herein in its entirety.

### FIELD OF THE PRESENT DISCLOSURE

Embodiments of the present disclosure relate to security solutions for utilities (e.g., power grid), particularly with respect to a network of embedded devices distributed within a utility infrastructure.

### BACKGROUND

Embedded devices installed as part of a smart power grid present a major security risk to the utility infrastructure because they are soft targets that allow an attacker to access critical assets, such as generators or control centers. Power grids operate in real-time, require constant monitoring, and require timely responses to maintain proper operations, often within time frames beyond which a human could react. The speed required for this kind of control has led to automation of many routine tasks, using devices such as generator governors and protective relays, for example. As a result, utilities have installed a number of resource constrained embedded devices that operate on the periphery of a Supervisory Control and Data Acquisition (SCADA) network. These resource constrained embedded devices located on the periphery of a network are also known as edge devices. An example of an edge device is a recloser control, which is used to configure how a utility's reclosers behave when a fault is detected in the power lines, and is often mounted inside household boxes or on utility poles in the field.

Networked edge devices present a major security challenge because these devices are relatively easy to access, have very little physical security, and have direct access to a utility's SCADA network. Therefore, edge devices provide potential openings for an attacker to disrupt large sections of a utility.

### SUMMARY

In an embodiment, a method for tamper detection on distributed utility infrastructure is provided. The method includes receiving, within a computer or microprocessor, sensor data from a plurality of sensors each positioned to detect physical events at an edge device of the utility infrastructure, and determining, from the sensor data, one or more indicators when the sensor data exceed predetermined threshold values, respectively. The method further includes updating, based upon the one or more indicators, a limited factor graph corresponding to at least a portion of the utility infrastructure, historical incident data, and relationships of the plurality of sensors. Additionally, the method includes identifying, from the limited factor graph, an event that is occurring in the edge device, deciding whether the event is a tamper event, and initiating mitigation of the tamper event.

In another embodiment, a system for tamper detection on distributed utility infrastructure is provided. The system includes at least one edge device, including a plurality of sensors positioned to detect events at the at least one edge device of the utility infrastructure, a first processor communicatively coupled to the plurality of sensors, a first memory communicatively coupled with the first processor, and a factor graph stored within the first memory. The system further includes at least one actuator communicatively coupled with the first processor, an information program comprising machine readable instructions stored within the first memory and, when executed by the first processor, capable of receiving data from the plurality of sensors. Additionally, the system includes processing the data to compare with predetermined threshold values to identify the presence of at least one indicator, updating the factor graph, based upon the at least one indicator, to determine an event that is occurring at the at least one edge device, and deciding whether at least one event is a tamper event. Additionally, the system includes an enforcement program comprising machine readable instructions stored within the first memory and, when executed by the first processor, capable of controlling the at least one actuator to mitigate the tamper event.

In another embodiment, a software product comprising instructions, stored on non-transitory computer-readable media, wherein the instructions, when executed by a computer, perform steps for tamper detection on distributed utility infrastructure is provided. The software product includes an information program for a) receiving values from the plurality of sensors and processing the values based upon predetermined thresholds to identify at least one indicator, b) updating, based upon the at least one indicator, a factor graph corresponding to at least a portion of the utility infrastructure, historical incident and user-defined data, and relationships of the plurality of sensors, c) determining, from the factor graph, an event that is occurring to the edge device, and d) deciding whether the event is a tamper event.

### BRIEF DESCRIPTION OF THE FIGURES

FIG. 1A is a block diagram illustrating one exemplary system for tamper detection on distributed utility infrastructure, according to an embodiment.

FIG. 1B is a block diagram illustrating further exemplary detail of a first location of FIG. 1A according to an embodiment.

FIG. 2 is a block diagram illustrating exemplary software program architecture for tamper detection on the distributed utility infrastructure of FIGS. 1A and 1B, according to an embodiment.

FIG. 3A is a diagram illustrating first exemplary factor graph for tamper detection on distributed utility infrastructure, according to an embodiment.

FIG. 3B is a diagram illustrating a second exemplary factor graph for tamper detection on distributed utility infrastructure, according to an embodiment.

FIG. 4 is a flow diagram illustrating one exemplary method for tamper detection on the distributed utility infrastructure of FIGS. 1A and 1B, according to an embodiment.

### DETAILED DESCRIPTION OF THE EMBODIMENTS

Embodiments of the present disclosure include a distributed, sensor-based system and method that use information from a utility network to decide if unwanted tampering is occurring and how to respond. Embodiments of the present disclosure collect information from sensors about the physical environment of devices on the edge of a Supervisory Control and Data Acquisition (SCADA) network, and use the data to determine what events might be affecting the devices. Monitored events include both environmental and human sources, ranging from malicious attacks to natural disasters. Once a decision is made that a detected event is caused by unwanted tampering (i.e., that a tamper event is occurring), an optimal sequence of responses is determined and executed for each affected device.

Compared to prior art systems and methods, embodiments of the present disclosure are capable of handling a wider range of events and of detecting tamper events at an earlier stage. Events include physical events, such as natural disasters, and legitimate events, such as technician service visits. Embodiments of the present disclosure implement decisions based on factor graphs that combine sensor data, user-defined relationships among sensors, historical incident data, and user-defined event probabilities, and time between incident data. A distributed nature of the devices is used to assist the decision process and to determine what type of event is occurring. For example, a single shaking device might suggest a different response than multiple shaking devices.

Factor graphs are used with embodiments disclosed herein as a fusion algorithm for sensor data. A factor graph is a bipartite graph that connects a set of nodes representing system variables with another set of nodes representing functions relating to the variables. If a function is dependent on a variable, an edge is added to the graph between the nodes representing this variable and function. Factor graphs allow for arbitrary factorizations of joint distributions to be used to describe event dependencies. For example, a specific sequence of indicators may signal the occurrence of a certain event, whereas those same indicators, when considered individually, might signal different events. With factor graphs, sequence detection is incorporated into factor functions, such as sequence tracking, conditional probability, node history, etc., each function enabling quicker attack detection. Factor graphs allow improved event detection and protection capabilities and improved flexibility in balancing security with availability.

Power grid SCADA networks differ from regular information technology (IT) networks in several ways. SCADA networks must operate correctly for as long as possible, during both accidental and malicious failures. Focus on resilient operations places a large responsibility on SCADA device protection to minimize false positives, and limits potential responses when a problem is detected. For example, a device may not be taken offline if doing so would cause a blackout. Power devices need to pass data back and forth within restricted timing windows. Causing a device to miss its timing windows prevents proper operation, which may be as problematic as having a compromised device. Power grid networks are often exposed to the elements, and thus are vulnerable to a wide range of natural phenomena ranging in severity from a tree branch falling on a power line to a large-scale natural disaster such as an earthquake or hurricane. Therefore, care must be taken to not overreact to these types of events.

Embodiments of the present disclosure include methods that provide a range of responses to a tamper event. These responses may be analyzed and adjusted by a user to balance availability with security and thereby keep the power grid operating as much as possible. This approach and flexibility benefits power engineers who have performance goals and operational-related events in mind, but may not have a large training data set at hand or have time to fine-tune a complex intrusion detection system.

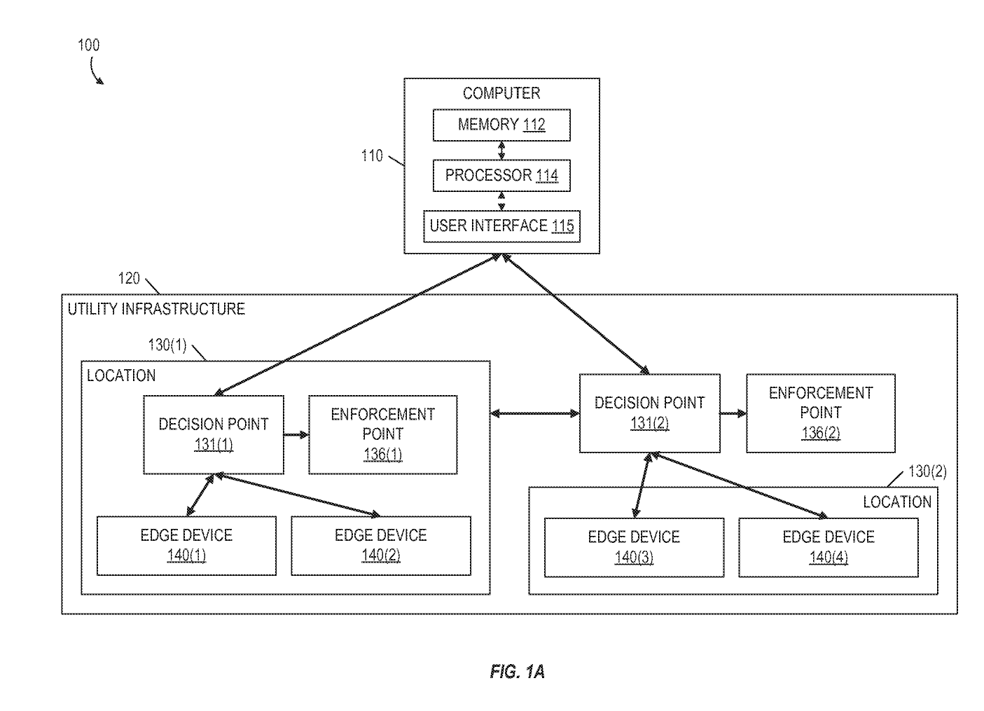

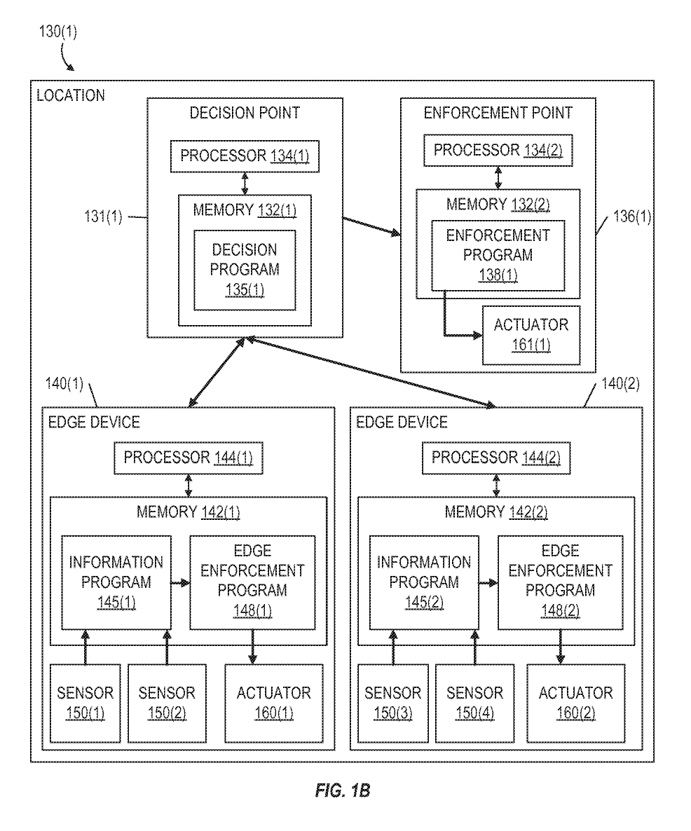

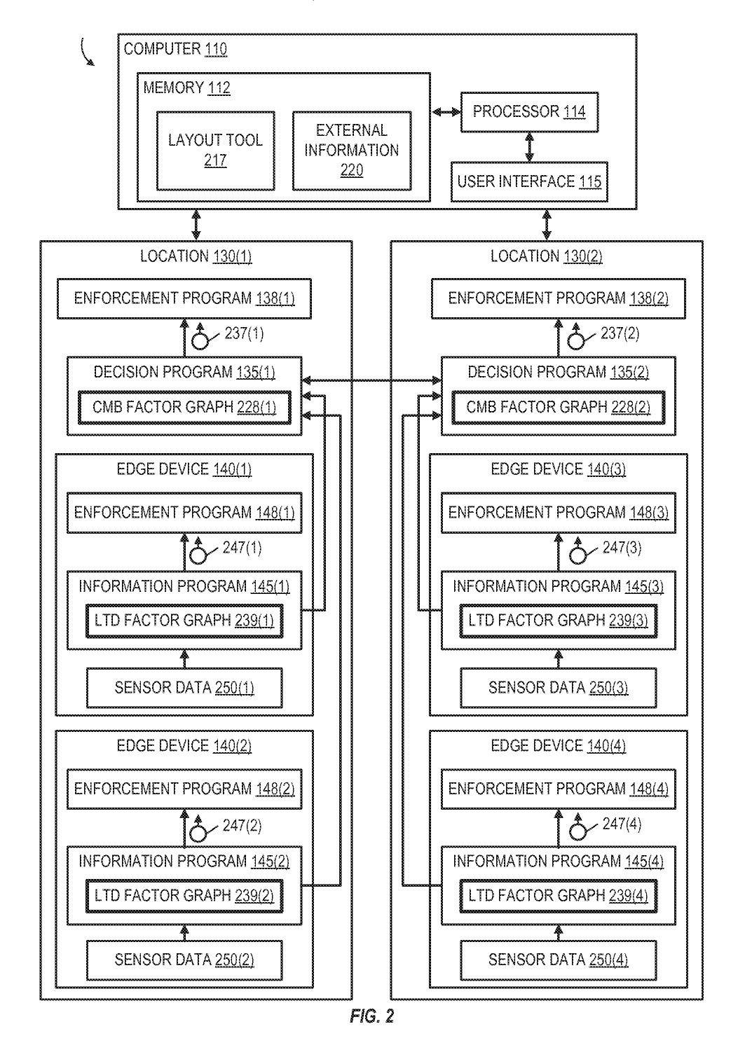

FIG. 1A is a block diagram illustrating one exemplary system 100 for tamper detection on distributed utility infrastructure. System 100 includes a computer 110 and a plurality of edge devices 140, decision points 131, and enforcement points 136 distributed within a utility infrastructure 120. Computer 110 has a memory 112, a processor 114, and a user interface 115, which enables a user to provide inputs and receive information from system 100. For example, the user may define relationships between a plurality of sensors, establish events corresponding to indicators, enter historical incident data, define what events are considered tamper invents, and establish instructions for mitigating tamper events. Computer 110 may be located within utility infrastructure 120 or located remotely as illustrated in FIG. 1A. In one embodiment, computer 110 is a mobile device capable of electronically communicating with utility infrastructure 120 via a wired or wireless connection. Computer 110 executes machine readable instructions, such as software programs described in software program architecture 200 (of FIG. 2) below.

Utility infrastructure 120 is physically distributed over a plurality of locations 130, illustratively shown as a first location 130(1) and a second location 130(2) in FIG. 1A. Each location 130 represents an electrical grid substation or a telephone pole cabinet, for example. Utility infrastructure 120 may include more than two locations 130 without departing from the scope hereof. Each location 130 includes one or more edge devices 140. First location 130(1) is illustratively shown with a first edge device 140(1) and a second edge device 140(2). Similarly, second location 130(2) is illustratively shown with a third edge device 140(3) and a fourth edge device 140(4). Each edge device 140 represents an embedded device such as a generator governor or a protective relay. Locations 130 may each include fewer or more than two edge devices 140 without departing from the scope hereof.

Each location 130 is communicatively coupled with at least one decision point 131 for receiving and processing data from edge devices 140, including from sensors, shown in FIG. 1B and described in further detail below. First location 130(1) is shown with a first decision point 131(1) communicatively coupled to both first edge device 140(1) and second edge device 140(2). Similarly, second location 130(2) is shown with a second decision point 131(2) communicatively coupled to third edge device 140(3) and fourth edge device 140(4). Optionally, first decision point 131(1) and second. decision point 131(2) may communicate with each other. Decision points 131 may be located within a location 130 or remotely. For example, first decision point 131(1) is located within first location 130(1) and second decision point 131(2) is located outside second location 130(2), as depicted in FIG. 1A.

Each location 130 also includes an enforcement point 136 that operates to mitigate tamper events, such as non-malicious tampering from fallen trees, technician visits, or wildlife and malicious tampering such as device data access, device additions, device modification, device replacement, etc.; and may further include attempts at such. First enforcement point 136(1) of first location 130(1) receives instructions from first decision point 131(1) and operates to mitigate tamper events within first location 130(1). Similarly, second enforcement point 136(2) receives instructions from second decision point 131(2) and operates to mitigate tamper events within second location 130(2).

FIG. 1B is a block diagram showing further exemplary detail of first location 130(1) of FIG. 1A. Each edge device 140 may include one or more sensors 150 that are positioned to detect events proximate the edge device. For example, first edge device 140(1) includes a first sensor 150(1) and a second sensor 150(2) for detecting events proximate first edge device 140(1). Similarly, second edge device 140(2) includes a third sensor 150(3) and a fourth sensor 150(4) for detecting events proximate second edge device 140(2). Sensors 150 are selected from the group including photo-sensors or photo-detectors to sense light, accelerometers to sense shaking or vibration, thermocouples or resistance temperature detectors to sense temperature, switches to detect open versus closed panels or doors, and so on. Each edge device 140 may include fewer or more sensors 150 without departing from the scope hereof.

Data from sensors 150 may be processed to produce indicators for comparing to predetermined threshold values. Indicators may correspond to an event that is occurring. For example, if an accelerometer senses vibrations in a first axis, a second axis, and a third axis, vibration data from the first, second and third axes may be combined to provide a single indicator representing an overall magnitude of vibration for comparing to a predetermine threshold. Processing of data from sensors 150 to produce indicators may be performed within each edge device 140, for example.

Each edge device 140 includes computing capability for processing data from sensors 150, illustratively shown as a memory 142 and a processor 144, which may be implemented as a microprocessor or microcontroller. Each edge device 140 has an information program 145 and an edge enforcement program 148, each implemented as machine readable instructions stored in memory 142 and executed by processor 144 to receive and process data from sensors 150. In the example of FIG. 1B, first edge device 140(1) includes processor 144(1) and memory 142(1) with first information program 145(1) and first edge enforcement program 148(1). Similarly, second edge device 140(2) includes processor 144(2) and memory 142(2) with second information program 145(2) and second edge enforcement program 148(2).

In one example of operation, information program 145 periodically (e.g., every few seconds) receives and processes data from local sensors 150 to compare with predetermined threshold values to determine if events are affecting edge device 140.

Edge enforcement programs 148 may enforce decisions via an actuator 160. For example, edge enforcement program 148(1) sends instructions to actuator 160(1) for enforcing a mitigation response to unwanted tampering. Actuators 160 may include one or more of network switches, routers, relays, or protective relays for example.

As shown in FIG. 1B, first decision point 131(1) includes computing capability and is illustratively shown with a processor 134(1) and a memory 132(1), implemented as a microprocessor or microcontroller for example. Memory 132(1) is shown storing a first decision program 135(1), implemented as machine readable instructions that are executed by the processor 134(1) to receive and process information from edge devices 140(1) and 140(2). First enforcement point 136(1) also includes computing capability that is illustratively shown as a processor 134(2) and a memory 132(2), which may be implemented as a microprocessor or microcontroller. A first enforcement program 138(1) is shown stored within memory 132(2), implemented as machine readable instructions that are executed by processor 134(2) to receive and process input from first decision point 131(1) to enforce mitigation of tamper events. First enforcement program 138(1) may enforce decisions via an actuator 161(1), similar to actuators 160 described above. First enforcement program 138(1) may be located separately from edge devices 140(1), 140(2) in order to enforce higher level network decisions. For example, if a tamper event may affect all devices 140 in location 130(1), appropriate mitigation may require isolation and rerouting or quarantining of the entire location 130(1).

In an embodiment, first decision point 131(1) and first enforcement point 136(1) are co-located and share common computing components, such that first decision program 135(1) and first enforcement program 138(1) are stored together in a single memory 132 and executed by a single processor 134.

In an embodiment, enforcement points 136 are optimally positioned across locations 130 of utility infrastructure 120 to respond to decisions made by information programs 145 and decision points 131. For example, a first enforcement point 136(1) is co-located with first decision point 131(1) in first location 130(1). In another example, an edge enforcement program 148(2) may be located with second information program 145(2) within edge device 140(2), for example. Enforcement points 136 may be located remotely from locations 130 without departing from the scope hereof. Enforcement points 136 and edge enforcement programs 148 (of FIG. 1B) allow mitigation of tamper events in an appropriate location depending on a particular situation. For example, erasing secret data on second edge device 140(2) may be best handled by second edge enforcement program 148(2), whereas filtering network traffic may be more appropriate for first enforcement point 136(1). Enforcement points 136 and edge enforcement programs 148 are not limited to making single responses to a decision, but instead may execute an ordered series of responses to mitigate problems. Exactly which responses to take, and what order to take them in, may occur automatically and are predetermined by the user. Enforcement points 136 and edge enforcement programs 148 may activate an alarm to notify the user of tamper events and may optionally require input from the user before a decision is enforced.

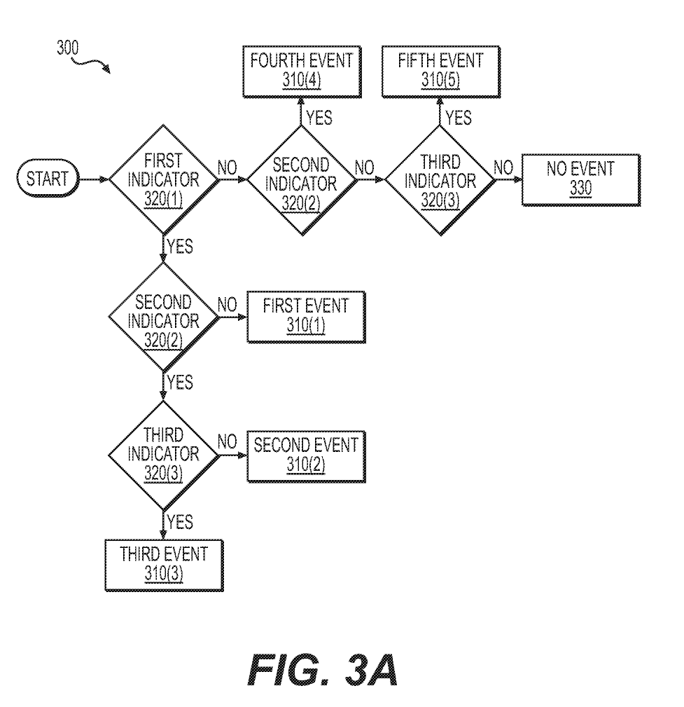

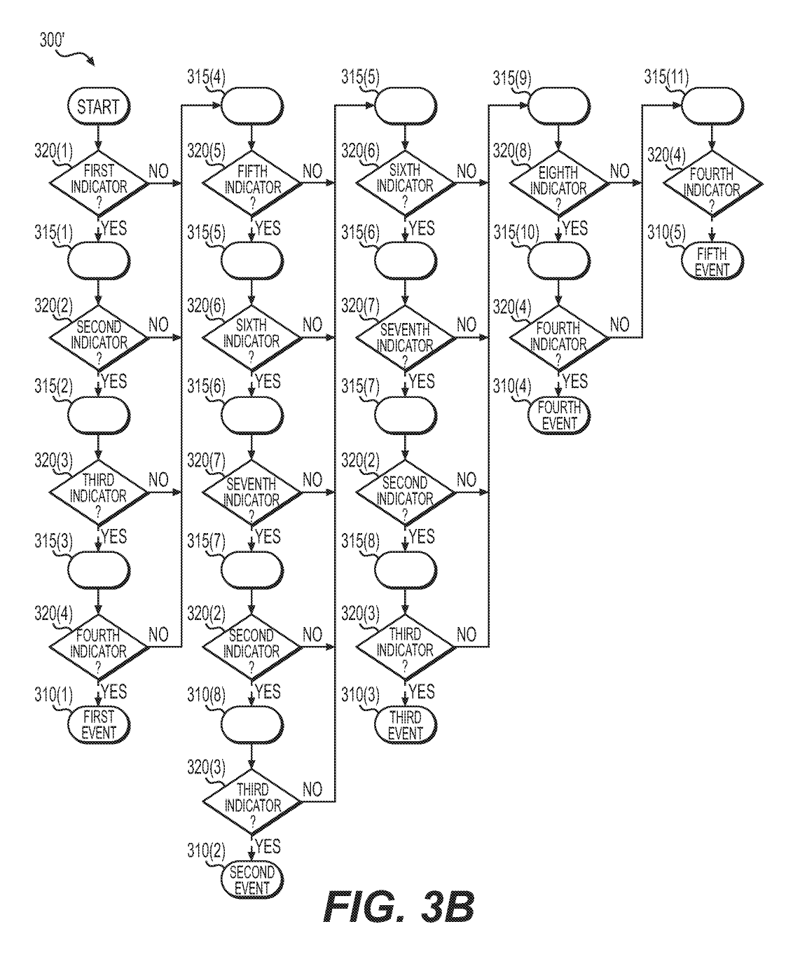

FIG. 2 is a block diagram illustrating exemplary software program architecture 200 for tamper detection on distributed utility infrastructure 120 of FIGS. 1A and 1B. Each information program 145 operates within one edge device 140 and operates to process sensor data 250 to detect events local to their respective edge device 140, and to determine that the detected events are caused by unwanted tampering (i.e., are tamper events). Information program 145(1) of edge device 140(1) receives sensor data 250(1) from sensors 150(1) and 150(2) of edge device 140(1) and incorporates these sensor data 250(1) into a limited (LTD) factor graph 239(1). An example of limited factor graphs 239(1) is shown in FIG. 3A as factor graph 300, described below. Similarly, information program 145(2) receives and incorporates sensor data 250(2) into limited factor graph 239(2), information program 145(3) receives and incorporates sensor data 250(3) into limited factor graph 239(3), and information program 145(4) receives and incorporates sensor data 250(4) into limited factor graph 239(4).

Information programs 145 process limited factor graphs 239 to determine what events are occurring, to decide which of those events are tamper events, and to communicate the tamper events to an appropriate enforcement program 148. For example, information program 145(1) may decide that an event is a tamper event 247(1) and communicate the tamper event 247(1) to enforcement program 148(1) Similarly, information program 145(2) may decide upon and communicate a tamper event 247(2) to enforcement program 148(2), etc. Information programs 145 may also incorporate external information 220 into limited factor graph 239. For example, user interface 115 may provide external information, such as historical incident data, service information, and user-defined relationships of sensors 150.

Each information program 145 operates to make local decisions, based upon its limited factor graph 239, within its corresponding edge device 140. Since limited factor graph 239 is updated only with sensor data 250 local to edge device 14 limited factor graph 239 is more limited than combined factor graph 228. Each information program 145 has a limited factor graph 239 based on indicators 320 corresponding to local sensors and may not be able to determine event 310. If the information program 145 is unable to make a decision based upon sensed local events, information program 145 may request assistance from or send an alert to a corresponding decision point 131 (see Example Scenario 1, below). Since combined factor graph 228 is based upon information combined from multiple edge devices 140, each decision program 135 may make more informed decisions than information program 145. An example of combined factor graph 228(1) is shown in FIG. 39 as factor graph 300′, described below. As shown within FIGS. 1A and 1B, decision programs 135 operate within a corresponding decision point 131 at its location 130 and operate to process information received from information programs 145 of corresponding local edge devices 140 or to process lack of values received from information programs.

When decision program 135(1) receives information that is a non-alert or non-tampering information from either information program 145(1) or 145(2), the decision program 135 determines if it is a legitimate message, if so, then the decision program 135(1) may await further data, otherwise will calculate an overall state Iₒᵥₑᵣₐₗₗ of location 130(1), which may utilized at that time or stored for later use.

In calculating Iₒᵥₑᵣₐₗₗ, the decision program 135 constructs its set of I indicators 320, and decision program 135(1) sets an overall indicator state Iₒᵥₑᵣₐₗₗ as follows:

Iₒᵥₑᵣₐₗₗ={maj(i₁), maj(i₂), . . . , maj(i₁)}

maj(iₚ)={1 if a majority of information programs see sensor mₚ as present; 0 otherwise},

The presence (i.e. 1) or absence (i.e. 0) of an iₚ indicator 320 is calculated by looking at its corresponding sensor mₚ to see if the sensor has reached or crossed an operator-defined threshold. Indicators 320 can be classified as local, in which their value depends solely on the value of the sensor at the edge device 140 located at the sole location 130, or regional, which depend on the sensor values of all of the information programs 145 operating under a decision program 135 that communicates with several. locations 130.

In an embodiment, if any of the maj(iₚ) functions do not find a clear majority (e.g., the information programs are evenly split), first decision point 131(1) may request assistance from a second decision point 131(2) or can break ties by declaring that an even split will always be reported as present or absent. If a second decision point 131(2) is chosen, the second decision point 132(2) attempts to break the tie by combining its information with that of first decision point 131(1) in combined factor graph 228(2) for processing, and sending a decision to first decision point 131(1) about what event 310 is occurring. If event 310 represents a tamper event, then that tamper event is passed along to first enforcement point 136(1) to initiate mitigation.

When a decision program 135 has received an alert from an information program 145, the decision program 135 may wait a short period of time to receive other information from other information programs 145, so as to make sure the most current data is available and to check the indicators 320 against known events presetting. In certain embodiments, indicators include information other than processed sensor data 250. During the waiting time period, the decision program 135 may query to determine if there is a scheduled maintenance or if the time falls with a known maintenance window for the edge device 140 in question. For example, if the decision program 135 is aware when first edge device 140(1) is being serviced, this service information may be incorporated as first indicator 320(1) in combined factor graph 228(1). Another example is weather information. Relevant weather information, such as hurricanes and tornadoes, may be incorporated as indicators 320 in combined factor graphs 228.

Either firstly or after a short wait period, the decision program 135(1) generates a combined factor graph 228(1), and thereby identifies events local to location 130(1) and decides whether any of these events are a tamper event 237(1). Similarly, decision program 135(2) receives information from information programs 145(3) and 145′4) to generate combined factor graph 228(2), identifies events local to location 130(2), and decides whether any of these events are a tamper event 237(2). Decision programs 135 may also receive external information 220 and incorporate it into their corresponding combined factor graph 228. Decision programs 135 process combined factor graph 228 to determine what events are occurring and decide if the events are tamper events.

A specific sequence of indicators 320 may be more instructive about what event is occurring than just the presence or absence of indicators 320. In an embodiment, information programs 145 and decision programs 135 may incorporate sequences of indicators 320 into their factor graphs 239, 228, respectively. The user may define sequences of indicators 320 that indicate particular events 310. For example, if first indicator 320(1) is present, followed by second indicator 320(2) being present, followed by third indicator 320(3) being present in a chronological sequence and within a maximum amount of time that can pass between each indicator, this may indicate a particular event 310 (see Example Scenario 2, below). The user may also provide information about the importance of events 310 and use that information to rank the order in which events are determined by factor graphs 239, 228.

For example, first information program 145(1) updates limited factor graph 239(1) based on first and second indicators 320(1), 320(2) and determines that shaking is occurring within first edge device 140(1) but is unable to determine what event 310 is causing the shaking. In this case, first information program 145(1) requests assistance from decision program 135(1). Similarly, third information program 145(3) is unable to determine event 310 from only indicator 320(3) and requests assistance from decision program 135(1).

Decision program 135(1) queries first information program 145(1) and third information program 145(3), identifies the presence of shaking by first, second, and third indicators 320(1), 320(2), and 320(3), and updates its combined factor graph 228(1) accordingly. The decision program 135(1) may verify that a message from the information program 145(1) is fresh and from a legitimate information program 145(1). Decision program 135(1) may also include external information in combined factor graph 228(1) that may be used to clarify and qualify detected events. This external information may include one or more of weather information, relationships between sensors, and historical incident data. For example, if weather information indicates that a hurricane is occurring, the presence of shaking may be due to high winds. If second location 130(2) is a telephone pole that is located one mile from first location 130(1), the presence of simultaneous shaking in first, second, and third indicators 320(1), 320(2), 320(3) indicates widespread shaking. Decision program 135(1) processes combined factor graph 228(1), updated with available information, and decides what event is happening. Decision program 135(1) combines indicators 320 provided by requesting tamper information programs 145 in combined factor graph 228(1). Decision program 135(1) then processes combined factor graph 228(1) to determine probabilities of events 310 and makes a final decision as to what event 310 is occurring. In the case of widespread shaking, decision program 135(1) decides that event 310(3) represents an earthquake that is occurring.

In an embodiment, first information program 145(1) may stop reporting data to first decision point 131(1), in which case the data are declared stale and removed from combined factor graph 228(1). First decision point 131(1) may then determine if a further response is needed due to the absence of received data from first information program 145(1). Also, the decision program 135 may periodically look for lost information programs 145 and remove them from future calculations If an information program is lost, this event may be sent to the enforcement program 148 for further action.

Further, decision program 135 may receive information from other decision programs 135. For example, decision program 135(1) may exchange information with decision program 135(2). Thus, each combined factor graph 228 may be indicative of events beyond its corresponding location 130, and may include events of all utility infrastructure 120. Additional hierarchical levels of decision programs 135 may be included to handle decision making for utility infrastructure 120 of increased complexity.

It is also foreseen that a response suggestion program may offer the user advice on how to modify the decision program 135. One such modification may be if an event 310 has an especially long indicator 320 sequence, the tool will suggest adding pre-events (not shown) that detect when an event 320 is about to occur, allowing the system to take a pre-emptive response. Additionally, if two events have similar event sequences but different response sequences, the response suggestion program may recommend taking responses from one event 310(1) and applying them to the other 320(2).

In an embodiment, computer 110 also includes a layout tool 217, stored in memory 112 and having machine readable instructions that are executed by processor 114 to interact, via user interface 115, with the user of computer 110 to receive external information 220. Layout tool 217 allows the user to select positions for decision points 131 (of FIGS. 1A and 1B), for example. In one embodiment, layout tool 217 calculates optimal positions for decision points 131 within utility infrastructure 120 based on a predefined network topology file indicative of utility infrastructure 120. The user may also interact with layout tool 217 to adjust positions of decision points 131 based on monitoring preferences.

FIG. 3A is a diagram illustrating a portion of one exemplary factor graph 300 for tamper detection on distributed utility infrastructure 120 of FIGS. 1A and 1B. Factor graph 300 may represent a portion of limited factor graphs 239 and combined factor graphs 228. Limited factor graphs 239 are used within information programs 145 and operate as a fusion algorithm for sensor data 250, as illustrated in FIG. 2. Similarly, combined factor graphs 228 are used within decision programs 135 and operate as a fusion algorithm for data from information programs 145 and other decision programs 135, as illustrated in FIG. 2.

Factor graph 300 includes two datasets: events 310 and indicators 320, but may further include a third such as time (not shown). Events 310 represent the set of physical events that system 100 is capable of detecting from its network of distributed sensors 150. Tamper events are a subset of events 310 that represent unwanted tampering. Sensors 150 generate sensor data 250 that are processed and compared with predetermined threshold values in the processor of the edge devices to identify a presence or absence of indicators 320. For example, if a sensor datum exceeds its predetermined threshold value, a corresponding indicator 320 is identified as present, otherwise the corresponding indicator 320 is identified as absent. Indicators 320 are used by factor graph 300 to determine what events 310 are occurring.

In the example of FIG. 3A factor graph 300 determines events 310 based upon indicators 320. For example, if first indicator 320(1) is absent (represented as a “NO” decision), second indicator 320(2) is absent, and third indicator 320(3) is absent, then factor graph 300 determines that no event 330 is occurring. In another example shown in FIG. 3A, when first indicator 320(1) is present (represented as a “YES” decision) and second indicator 320(2) is absent, then a first event 310(1.) is determined as occurring. Similarly, if first and second indicators 320(1), 320(2) are present and third indicator is absent, a second event 310(2) is determined as occurring. Similarly, if first, second, and third indicators 320(1), 320(2), 320(3) are all present, a third event 310(3) is determined as occurring. in another example if the first indicator 320(1) is absent, but the second indicator 320(2) is present (represented as a “YES” decision), then a fourth event 310(4) is determined as occurring. Likewise if both the first indicator 320(1) and the second indicator 320(2) are absent, but the third indicator 320(3) is present (represented as a “YES” decision), then a fifth event 310(5) is determined to be occurring. Factor graph 300 may include greater or fewer than three indicators, and the indicators may be arranged to correspond to any distributed utility infrastructure, without departing from the scope hereof.

For example, event 310(3) is an earthquake, and indicators 320 result from sensor data detected by sensor 150 capable of detecting an earthquake, such as an accelerometer. When a vibration sensed by the accelerometer exceeds a predetermined threshold value, the corresponding indicator 320 is identified as present, thereby indicating that shaking is occurring. When multiple accelerometers sense vibrations exceeding their predetermined threshold values, the corresponding indicators 320 are identified as present and factor graph 300 determines that widespread shaking is occurring. For example, if first, second, and third indicators 320(1), 320(2), 320(3) indicate widespread shaking, factor graph 300 may determine, based on relationships between the accelerometers (e.g., proximity) and historical event probabilities, that third event 310(3) (an earthquake) is occurring.

For example, consider where first location 130(1) of FIG. 1A is a substation and first and second sensors 150(1), 150(2) of FIG. 1B are first and second accelerometers, respectively, second location 130(2) is a box on a telephone pole, and third edge device 140(3) of FIG. 2 has a third sensor (not shown) that is a third accelerometer. Information programs 145 process sensor data 250 and compares the data to predetermined threshold values to identify the presence or absence of indicators 320. For example, if shaking is occurring at first edge device 140(1), first information program 145(1) receives and processes sensor data 250(1) from first and second sensors 150(1), 150(2) and identifies that first and second indicators 320(1), 320(2) are present (e.g., vibration from first and second accelerometers exceeds a predetermined threshold value, indicating that shaking is occurring). Similarly, third information program 145(3) receives and processes sensor data 250(3) from the third sensor and, if shaking is occurring, sets third indicator 320(3) as present.

FIG. 3B is a diagram illustrating a portion of one exemplary factor graph 300′ for tamper detection on distributed utility infrastructure 120 of FIGS. 1A and 1B. Factor graph 300′ includes three datasets: events 310′, time 315′ and indicators 320′. As a combined factor graph incorporates several limited factor graphs within it, events 310 and indicators 320′ are substantially similar to their counterparts' events 310 and indicators 320, as described above. Time 315′ is the time window allotted between events, in the illustrated embodiment there are eleven unique monitored time windows 315′.

As a non-limiting example, in a device credential heist, a sequence of indicators (o, l, m, p) may look like: the attacker opens (o) the device case, the attacker uses a light source (l) to locate the protected memory chip, the attacker attempts to pierce the potted mesh (m) and finally, the attacker probes (p) the chip underneath to extract the secret key. The time windows 315′ for this scenario may be set as follows: 1) The window 315′(l) between o and l can be fairly short (sixty seconds or less), since ambient light will be let in as soon as the device opens, and the attacker will use an external light source (for example, a flashlight) if there is not enough ambient light; 2) The l-m window 315′(2) can be set to be a bit longer (perhaps several hours), as we expect an attacker to be more cautious as he or she tries to penetrate the mesh's potting material without tripping the mesh sensors; and 3) the m-p window 315′(3) can be somewhere in between the prior two (roughly sixty minutes), as the attacker may need some time to place the probes while continuing to avoid the sensor mesh. It is also understood that time windows may not just be just between the specified indicators, but it is envisioned that time windows may also be measured between the other indicators, i.e. o-m or o-p, etc.

In the example of FIG. 313 factor graph 300′ determines events 310′ based upon indicators 320′. In the illustrated example, there are five events 310′ that are monitored. For example, the first event 310′(1) is determined to be occurring, if first indicator 320′(1) is present (represented as a “YES” decision) within time window 315′(1) after the second indicator 320′(2) is present within time window 315′(2) after the third indicator 320′(3) is present within the time window 315′(3) after the fourth indicator 320′(4). Similarly, the third event 310′(2) is determined to be occurring, if sixth indicator 320(6) is present (represented as a “YES” decision) within time window 315′(6) after the seventh indicator 320′(7) is present within time window 315′(7) after the second indicator 320′(2) is present within the time window 315(8) after the third indicator 320′(4) is present. The second event 320′(2) is determined to be occurring if the third event is determined to be occurring along with the fifth indicator 320′(5) is present within the time window 325(5). Similary, fourth event 310′(4) is determined to be occurring when the fifth event 310′(5) is determined to be occurring and the eighth indicator 320(8) is present within a time window 315′(10) of the fourth indicator 320′(4). The third event 310′(3) and fourth event 310′(4) are likely done by the decision program 135 when fifth indicator 320′(5) and eighth indicator 320′(8) are external, global, or regional indicators, see example above regarding regional shaking or earthquake.

For an event to be determined to be occurring the decision program 135 must be looking backward through indicators 320 and if all indicators exist within each time window or time frame 315′, then an event 310′ is said to be occurring. For example, event 310′(1) may be a malicious removal of an edge device to be replaced or modified for later malicious attacks at a later time. The decision program 135 would be looking for a local shaking, i.e. significant movement generated by the attacker's rough treatment of the lock by means of a vibration sensor or accelerometer exceed a predetermined value at fourth indicator 320′(4); an opening of the cabinet door at third indicator 320(3), followed by a light source reaching the device with indicator 320′(2), and concluded by a disconnecting of the device's network cable as first indicator 320(1). While the timing windows are not explicitly set within the narrative, one sets the time windows 315′ in this event to be short under the presumption an attacker would go through this attack in quick succession and not wait for long periods between each step, as either they would be concerned about being noticed and reported, or they are confident that they will not be noticed (for example, they are disguised as a technician) and will not want to delay their gratification.

Another example would be a malicious event 310(3) and a benign event 310(2) with regards to a USB firmware update. Both an attacker and a legitimate technician start by opening the cabinet door which could be third indicator 320(3), which lets light reach the device, a light sensor data 250 being indicator 320(2), followed by removing a USB plug which is the seventh indicator 320(7), and finally plugging in a USB device as the sixth indicator 320(6). The key difference again lies with the explicit authorization of the utility, and the decision program 135 can differentiate the two scenarios with an external indicator 320′(5) saying whether or not the update is scheduled (s). It is important to note that such a scenario may have to have the benign event 320′(3) ranked higher than the malicious one 320′(2).

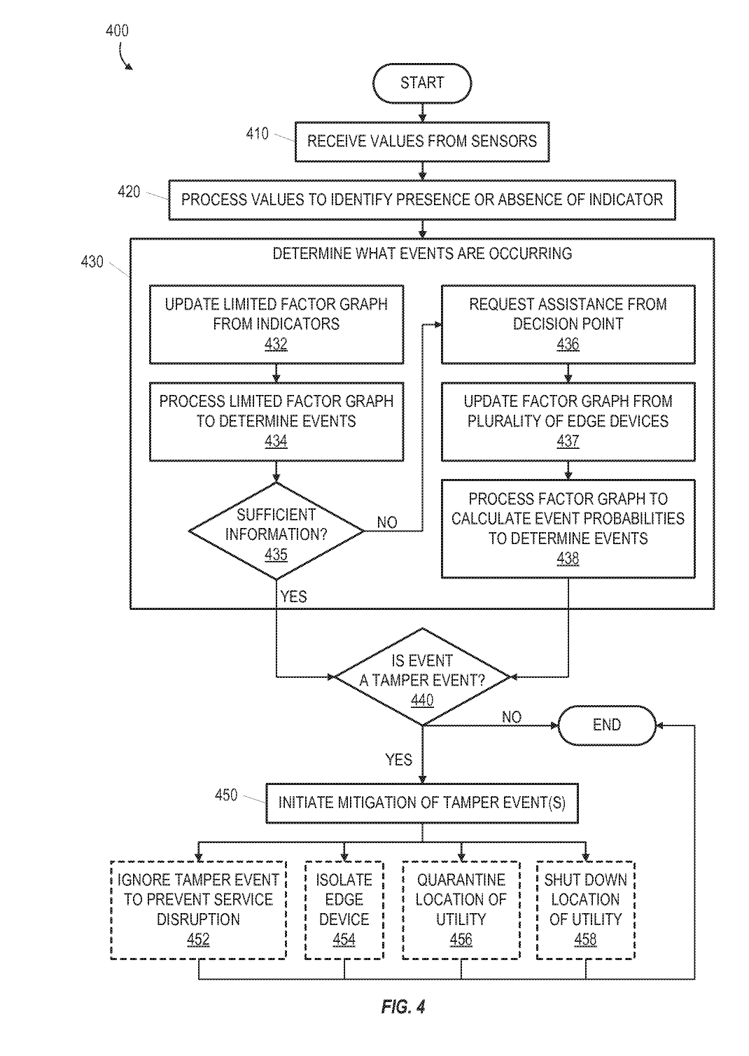

FIG. 4 is a flow diagram illustrating one exemplary method 400 for tamper detection on distributed utility infrastructure 120 of FIGS. 1A and 1B. Method 400 is implemented by one or more of programs 135, 145, and 148 of system 100, for example.

In a step 410, method 400 receives data from a plurality of sensors of an edge device of the utility infrastructure. In one example of step 410, sensor data 250(1) are received by first information program 145(1) from sensors 150(1) and 150(2) located within first edge device 140(1) at first location 130(1).

In a step 420, method 400 processes sensor data to identify a presence or absence of an indicator. In an example of step 420, first information program 145(1) processes first sensor data 250(1) according to machine readable instructions to compare with predetermined threshold values. When sensor data 250(1) exceeds predetermined threshold values, step 420 identifies the presence of a corresponding indicator 320(1). Similarly, when sensor data 250(1) does not exceed predetermined threshold values, step 420 identifies the absence of a corresponding indicator 320(1).

Processing sensor data 250 by information programs 145 in step 420 may further include signal processing, averaging, smoothing, tracking over time, or otherwise manipulating sensor data 250. In an embodiment, an accelerometer may provide vibration data along three independent axes, and first information program 145(1) may combine the three axis data into an overall magnitude of vibration value to compare against a predetermined threshold value and identify a corresponding indicator 320.

According to another embodiment, information program 145(1) tracks first sensor data 250(1) for a predetermined amount of time, and determines if first sensor data 250(1) exceeds the predetermined threshold value more than once within the predetermined amount of time. Exceeding the predetermined threshold value more than once may identify additional indicators 320. For example, exceeding the predetermined threshold value once in a predetermined amount of time may identify a first indicator 320(1) as present, and exceeding the threshold value twice in the predetermined amount of time may identify a second indicator 320(2) as present, and so on.

According to another embodiment, information program 145(1) tracks first sensor data 250(1) for a predetermined amount of time, and determines if first sensor data 250(1) exceeds the predetermined threshold value for longer than a predetermined amount of time. Exceeding the predetermined threshold value for a longer time period versus a shorter one may identify additional indicators 320. For example, exceeding the predetermined threshold value for less than a predetermined amount of time may identify a first indicator 320(1) as present, and exceeding the threshold value for more than a predetermined amount of time may identify a second indicator 320(2) as present, and so on.

In a step 430, method 400 determines what events, if any, are occurring at an edge device and whether or not those events are tamper events. In an example of step 430, first information program 145(1) determines, using limited factor graph 239(1), what events 310 are occurring in edge device 140(1) based on corresponding indicators 320. Step 430 may include sub-steps 432 to 438.

In a step 432, method 400 updates a limited factor graph using indicators that indicate whether sensor data received from the plurality of sensors exceeds predetermined threshold values. In an example of step 432, information program 145(1) includes instructions to update limited factor graph 239(1) with indicators 320, which were processed from sensor data 250(1) in step 420. Indicators 320 may include sequence information from individual indicators (e.g., first indicator 320(1) is identified as present prior to second indicator 320(2) being identified as present, etc.). Limited factor graph 239(1) is considered limited because information program 145(1) has access to indicators 320 corresponding to sensor data 250(1) within first edge device 140(1), but not from other edge devices.

In a step 434, method 400 processes the limited factor graph to determine what events, if any, are occurring. In an example of step 434, first information program 145(1) processes limited factor graph 239(1) to determine what events 310 are occurring within first edge device 140(1). However, first information program 145(1) includes limited factor graph 239(1), which is limited to local information from first edge device 140(1), which means that certain events 310 may not be determined.

Step 435 is a decision. If, in step 435, method 400 determines that first information program 145(1) has sufficient information to determine what events 310 are occurring, then method 400 continues with step 440; otherwise, method 400 continues with step 436.

In a step 436, method 400 requests assistance from a decision point. In an example of step 436, first information program 145(1) requests assistance from a first decision point 131(1). For example, first decision point 131(1) may use first decision program 135(1) to determine an overall state of first location 130(1) by combining indicators 320 from first and second information programs 145(1), 145(2) in combined factor graph 228(1).

In a step 437, method 400 updates a factor graph using indicators processed from sensor data from a plurality of edge devices within the distributed utility infrastructure. In an example of step 437, first decision program 135(1) updates combined factor graph 228(1) to incorporate indicators 320 processed from sensor data 250(1) of first edge device 140(1) and sensor data 250(2) of second edge device 140(2) to make a more informed decision than information program 145(1) could from first edge device 140(1) alone.

In a step 438, method 400 processes the factor graph to calculate probabilities of events and make a final determination as to what event is occurring. In an example of step 438, first decision program 135(1) uses instructions to process first combined factor graph 228(1) updated in step 437. In an embodiment, first decision program 135(1) calculates an overall indicator state -overall and uses combined factor graph 228(1) to calculate event probabilities for determining what events 310 are occurring. In another example of step 438, first decision program 135(1) processes sequences of indicators 320 within first combined factor graph 228(1) to determine what events 310 are occurring.

Step 440 is a decision. If, in step 440, method 400 determines that one or more events 310 of step 434 or step 438 are tamper events, then method 400 continues with step 450; otherwise, method 400 terminates.

In step 450, method 400 initiates mitigation of the tamper event. In an example of step 450, where step 450 is preceded by step 438, first enforcement program 138(1) receives a determination of what events 310 are occurring from first decision program 135(1), for example, and executes instructions to initiate appropriate mitigation of the tamper events identified in decision step 440. In another example of step 450, where step 450 is preceded by step 435, a first edge enforcement program 148(1) receives a determination of what events 310 are occurring from a first information program 145(1) and executes instructions to initiate appropriate mitigation of the tamper events identified in decision step 440.

Method 400 may implement one or more of the following exemplary mitigation responses. In step 452, method 400 ignores the tamper events to prevent disruption of utility service. In an example of step 452, a tamper event detected in second edge device 140(2) is ignored to maintain operation throughout utility infrastructure 120.

In a step 454, method 400 electronically isolates at least one edge device to prevent spreading of the tamper events to other devices of the SCADA network. In an example of step 454, second edge enforcement program 148(2) uses instructions to electronically isolate second edge device 140(2) via an actuator 160(2), such as a network switch for example, to prevent tamper events from spreading to second decision point 131(2). The network switch (e.g., a router) may be instructed to ignore, or filter, any instructions (e.g., packets) being transmitted to, or received from, second edge device 140(2). Alternatively, second edge device may be partially or fully isolated from other devices of the SCADA network by revoking a certificate used to authenticate second edge device 140(2) with other devices on the network, for example. Each device 140 includes a certificate to encrypt and digitally sign each transmitted packet of information as a validating mechanism. Without a valid certificate, second edge device 140(2) may be effectively isolated.

In a step 456, method 400 electronically quarantines a location of the distributed utility infrastructure to prevent tamper events from spreading to other parts of the SCADA network. In an example of step 456, second enforcement program 138(2) electronically quarantines second location 130(2) to prevent spread of tamper events to first location 130(1) and to computer 110. Quarantining may be executed b: filtering network traffic via one or more network switches, or by revoking one or more device certificates, as described above.

In a step 458, method 400 shuts down at least one location of the distributed utility infrastructure to prevent catastrophic damage. In an example of step 458, power to second location 130(2) is shut down, forcing a disruption of utility service provided by second location 130(2), in order to prevent catastrophic damage to second location 130(2). Other mitigation responses may be appropriate without departing from the scope hereof. Following tamper event mitigation, method 400 terminates.

System 100, software program architecture 200, factor graph 300, and method 400 for tamper detection on distributed utility infrastructure are further described below by way of example scenarios. The example scenarios are intended to further clarify how method 400 may operate, using system 100, software programs of architecture 200, and factor graph 300, and should be interpreted as illustrative and not limiting.

Example Scenario 1:

In a first example scenario, consider that first sensor 150(1) of FIG. 1B is an accelerometer. Vibration data from first sensor 150(1) are received in step 410 of FIG. 3 by first information program 145(1). First information program 145(1) processes the accelerometer vibration data in step 420, which includes comparing the vibration data to predetermined thresholds, if shaking is present, first indicator 320(2) is identified as present in step 420. Accordingly, first information program 145(1) tries to determine what event is occurring in first edge device 140(1) in step 430. First information program 145(1) updates a limited factor graph, such as limited factor graph 239(1) of FIG. 2, with sensor data 250(1) in step 432. First information program 145(1) processes limited factor graph 239(1) in step 434, and decides, in step 435, that insufficient information is available to determine what event is causing the shaking.

Next, first information program 145(1) requests assistance from first decision point 131(1) in step 436. First decision point 131(1) deploys a first decision program 135(1), which requests monitoring from other information programs 145, such as second information program 145(2) of second edge device 140(2), which may monitor another accelerometer, namely third sensor 150(3). Additional information from second information program 145(2) is combined in a factor graph, such as combined factor graph 228(1), updated in step 437. First decision point 131(1) uses first decision program 135(1) to process first combined factor graph 228(1) in step 438. If second information program 145(2) determines that third sensor 150(3) exceeds a predetermined threshold for vibration, such that a second indicator 320(2) is present, first decision program 135(1) may decide, for example, that event 310 is an earthquake. The decision may depend on user-defined relationships between sensors 150(1), 150(3), such as a proximity between them, and other external information 220, such as weather information.

A decision is made (e.g., in step 440 of method 400) as to whether the event 310 is a tamper event. If a tamper event is occurring, the decision is transmitted to relevant enforcement points to initiate mitigation in step 450. In this example, the decision is transmitted to enforcement points 136(1) and first and second edge enforcement programs 148(1), 148(2), which may decide to pursue one of optional steps 452 to 458 to mitigate the tamper event.

Example Scenario 2:

In a second example scenario, edge device 140(1) represents a recloser control deployed in location 130(1) of a SCAD A network of a utility. For example, the recloser control is installed inside a metal cabinet and is located about three feet above the ground attached to a telephone pole. The cabinets are outfitted with a small set of sensors 150, including an accelerometer 150(1), light sensor 150(2), and a switch 150(3) that indicates whether or not the cabinet door is open. The user is particularly concerned about a bypass attack in which a hammer and chisel are used to break a lock off the cabinet, followed by replacement of edge device 140(1) with an exploit-equipped laptop, for example. The cabinet may be breached in other ways, such as by drilling or cutting with a torch. However, the hammer/chisel approach is particularly worrisome because it accesses the cabinet through a front door, similar to access by a utility service technician. Thus, the utility wants to ensure an ability to differentiate between an attack and a legitimate service call.

The factor graphs use indicators 320, as well as the relationships between the sensors 150, which may either be defined by past incident data and/or other external information 220.

First information program 145(1) receives accelerometer data in step 410 (of FIG. 4) and processes the vibration data to compare to predetermined vibration threshold values in step 420. If the vibration data exceeds predetermined vibration threshold values, a first indicator 320(1) is identified as present. First information program 145(1) updates limited factor graph 239(1) with first indicator 320(1) present in step 432, and processes the limited factor graph 239(1) in step 434. At this point, a decision is made in step 435. If insufficient information is available to determine what event is occurring, first information program 145(1) may request assistance from decision point 131 in step 436.

Next, first information program 145(1) receives light sensor data in step 410 and processes the light data to compare to predetermined light threshold values in step 420. If the light data exceeds predetermined light threshold values, a second indicator 320(2) is identified as present. First information program 145(1) updates limited factor graph 239(1) in step 432 with first and second indicators 320(1), 320(2) identified as present, including sequence information indicating that first indicator 320(1) was identified prior to second indicator 320(2), and processes the limited factor graph 239(1) in step 434.

Next, first information program 145(1) receives data from sensor 150(1) (e.g., a door switch) in step 410 and compares the sensor data to predetermined threshold values in step 420. If the sensor data exceeds the predetermined threshold values, the door switch is considered open and a third indicator 320(3) is identified as present. First information program 145(1) updates limited factor graph 239(1) in step 432 with first, second, and third indicators 320(1), 320(2) 320(3) present, including sequence information indicating that first indicator 320(1) preceded second indicator 320(2), which preceded third indicator 320(3).

Limited factor graph 239(1) is processed in step 438 to calculate event probabilities and compare these probabilities to historical incident or user-defined event probabilities to determine what event is occurring. For example, processing limited factor graph 239(1) with first indicator 320(1) identifying shaking followed by second indicator 320(2) detecting light followed by third indicator 320(3) indicating the door is open, and comparing to user-defined event probabilities, step 438 determines that the cabinet door was breached. A decision is made in step 440 that event 310 is a tamper event, and appropriate mitigation is initiated in step 450 and communicated to the corresponding edge enforcement program 148(1).

In an alternate circumstance, second indicator 320(2) may indicate light inside the cabinet, while at the same time third indicator 320(3) may indicate the cabinet door is closed. The apparent mismatch suggests that the cabinet has been breached in an inappropriate manner because light has been detected inside a closed door. By comparing to historical incident or user-defined events, a tamper event may be determined.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for tamper detection on distributed utility infrastructure, comprising:
receiving, within a first edge device of the utility infrastructure, sensor data from a plurality of sensors each positioned to detect physical events at the first edge device;
determining, from the sensor data, one or more indicators when the sensor data is outside a normal range value, respectively;
updating, based upon the one or more indicators, a limited factor graph corresponding to at least a portion of the utility infrastructure;
identifying, from the limited factor graph, an event that is occurring in the first edge device;
deciding whether the event is a tamper event; and
if the event is a tamper event, initiating mitigation of the tamper event.

2. The method of claim 1, the step of identifying comprising identifying, from the limited factor graph, a sequence of indicators corresponding to an event.

3. The method of claim 1, further comprising:
requesting, within a decision point that is communicatively coupled with the edge device, additional sensor data from a second edge device;
generating a combined factor graph based upon indicators received from the first edge device and the second edge device; and
identifying, from the combined factor graph, one or more events that are occurring in at least one of the first and second edge devices.

4. The method of claim 1, the step of initiating mitigation comprising ignoring the tamper event to prevent disruption of utility service.

5. The method of claim 1, the step of initiating mitigation comprising isolating electronically at least one edge device to prevent spreading of the tamper event.

6. The method of claim 1, the step of initiating mitigation comprising electronically quarantining a location of the distributed utility infrastructure to prevent the tamper event from spreading.

7. The method of claim 1, the step of initiating mitigation comprising shutting down at least one location of the distributed utility infrastructure to prevent catastrophic damage.

8. A system for tamper detection on distributed utility infrastructure, comprising:
at least one edge device comprising:
a plurality of sensors positioned to detect events at the at least one edge device of the utility infrastructure;
a first processor communicatively coupled to the plurality of sensors;
a first memory communicatively coupled with the first processor; and
a factor graph stored within the first memory;
at least one actuator communicatively coupled with the first processor;
an information program comprising machine readable instructions stored within the first memory that, when executed by the first processor, is capable of:
receiving data from the plurality of sensors;
processing the data to compare with predetermined threshold values to identify the presence of at least one indicator;
updating the factor graph, based upon the at least one indicator, to determine an event that is occurring at the at least one edge device; and
deciding whether at least one event is a tamper event; and
an first enforcement program comprising machine readable instructions stored within the first memory that, when executed by the first processor, is capable of controlling the at least one actuator to mitigate the tamper event.

9. The system of claim 8, the plurality of sensors configured to detect one or more of light, shaking, temperature, and an opened door.

10. The system of claim 8, a second enforcement program comprising a second processor communicatively coupled with the at least one edge device and a second memory communicatively coupled with the processor, wherein the second enforcement program is located remotely from the at least one edge device within the distributed utility infrastructure.

11. The system of claim 8, the at least one actuator comprising a network switch for filtering network traffic to and from the at least one edge device.

12. The system of claim 8, further comprising a supervisory control and data acquisition (SCADA) network for electronic communications between the plurality of sensors, the edge device, the processor, and a user interface.

13. The system of claim 8, further comprising a decision point having a second processor communicatively coupled with a second memory and a decision program having machine readable instructions stored in the second memory that, when executed by the second processor, is capable of:
updating the factor graph using values from a plurality of edge devices within the distributed utility infrastructure, thereby generating a combined factor graph; and
determining that the tamper event is occurring in at least one of the plurality of edge devices based on the combined factor graph.

14. The system of claim 13, the decision program further capable of identifying an event based on a sequence of received indicators.

15. The system of claim 13, the second enforcement program further capable of mitigating tamper events among a plurality of edge devices.

16. A software product comprising instructions, stored on non-transitory computer-readable media, wherein the instructions, when executed by a computer, perform steps for tamper detection on distributed utility infrastructure comprising:
an information program for a) receiving values from the plurality of sensors and processing the values based upon predetermined thresholds to identify at least one indicator, b) updating, based upon the at least one indicator, a factor graph corresponding to at least a portion of the utility infrastructure, c) determining, from the factor graph, an event that is occurring to the edge device, and d) deciding whether the event is a tamper event.

17. The software product of claim 16, wherein the information program includes instructions for identifying an event from a sequence of indicators.

18. The software product of claim 16, further comprising a decision program, the decision program comprising:
instructions for updating the factor graph using indicators from a plurality of information programs, thereby generating a combined factor graph, wherein each of the plurality of information programs is stored in memory of a respective edge device within the distributed utility infrastructure; and
instructions for determining what events are occurring in at least one edge device based on the combined factor graph; and
instructions for deciding whether any events that are occurring in the at least one edge device are tamper events based on historical incident and user-defined data, and relationships of the plurality of sensors.

19. The software product of claim 16, further comprising an enforcement program for initiating mitigation of tamper events.

20. The software product of claim 16, further comprising a decision program layout tool to calculate optimal positions for decision programs within the distributed utility based on a network topology file of the distributed utility.
